(19) United States
(12) Patent Application Publication
(10) Pub. No.: US 2003/0227099 A1
(43) Pub. Date: Dec. 11, 2003

(54) Embossing rainbow and hologram images

(76) Inventor: Munzer Makansi, Signal Mountain, TN (US)

Correspondence Address: LAWRENCE ISAKOFF, 1425 DRAKE ROAD, WILMINGTON, DE, 19803, US

(21) Appl. No.: 10/163,717

(22) Filed: Jun. 6, 2002

(51) Int. Cl. B29D 7/01

(52) U.S. Cl. 264/1.34

(57) ABSTRACT

An improved process is provided for creating a rainbow and/or hologram image on a thermoplastic fibrous sheet or polymeric film by embossing a diffraction grating and/or hologram groove pattern from an embossing shim onto the sheet or film. An embossing shim of flexible polymeric film is employed rather than a hard metal shim, as had been used heretofore.

### BACKGROUND OF THE INVENTION

1. Field of the Invention

This invention relates generally to a process for creating a rainbow and/or hologram image on a thermoplastic fibrous sheet or polymeric film by embossing a diffraction grating and/or hologram groove pattern from an embossing shim onto the sheet or film. More particularly, the invention concerns such a process in which the embossing shim is of flexible plastic film and not of hard metal, as had been used heretofore.

2. Description of the Prior Art

Hologram and/or rainbow images are produced by diffracting light from patterns of very fine grooves that were embossed on various surfaces, sheet-like materials, films, metal foils, and papers or fabrics coated or laminated with plastic. Processes are known in which fibrous sheets and/or polymeric films are embossed with very fine groove patterns so that when the surface of the sheet or film is viewed at an angle to incident light, the groove pattern produces rainbow and/or hologram images. For example, my earlier U.S. Pat. No. 6,120,710, the entire disclosure of which is hereby incorporated by reference, describes batch and continuous processes in which a sheet having thermoplastic fibrous elements is embossed with a pattern of very fine grooves. The disclosed process includes the steps of (a) softening the fibrous elements of the sheet, (b) placing a hard metal embossing shim having the desired groove pattern directly onto the surface of the fibrous sheet, (c) applying sufficient heat and pressure for a sufficient time to emboss the groove pattern onto the fibrous sheet and (d) separating the shim from the sheet. The rainbow and/or holographic images produced on the sheets and films by the known processes of the art are quite satisfactory. However, producing metal embossing shims with the desired fine groove patterns and cleaning the shims for re-use are often expensive and time-consuming tasks. The utility of the known processes could be considerably enhanced, if these tasks could be eliminated or simplified.

### SUMMARY OF THE INVENTION

The present invention provides an improved process for forming rainbow and/or hologram images on the surface of a fibrous sheet or polymeric film. As in known processes of the art, surface elements of the fibrous sheet and of the film are of a thermoplastic polymer, such as nylon, polyester, polyolefin and the like. Also, as in the known processes, the sheet or film is softened and subjected to sufficient heat and pressure while in contact with an embossing shim that has a groove pattern on its surface, to emboss the groove pattern upon the surface of the sheet or film. In accordance with the invention, the embossing shim is a polymeric film, preferably of polyester, and preferably of at least 0.0025-cm thickness. The film of the embossing shim has deep grooves of at least 1-micron depth, preferably in the range of 1.5 to 7 microns deep (as compared to a depth of about 0.05 to about 0.8 micron typically employed for the fine grooves of the shims of the processes of the art). In a preferred process of the invention, an embossing shim of flexible plastic film having a deep groove pattern is fed into the nip of calender rolls along with a fibrous sheet or second film to emboss the groove pattern onto the surface of the sheet or second film.

The film of the embossing shim embosses the desired pattern on a fibrous sheet or another film of the same or different polymer as the shim film and produces rainbow or hologram images equal in brightness and color intensity to those produced with conventional embossing shims of hard metal. The same embossing shim film can be re-used many times.

### BRIEF DESCRIPTION OF THE DRAWINGS

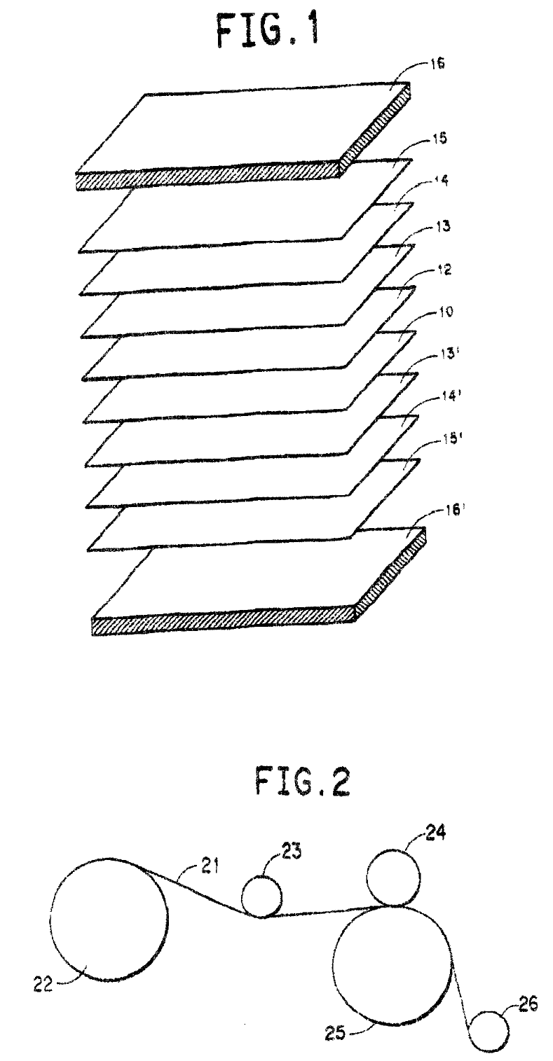

The invention will be more readily understood by referring to the drawings. FIG. 1 is an exploded schematic view of a preferred assembly of items for batch-embossing sheet 10, the items including an embosser 12 (also referred to as a “stamper”), release sheets 13, 13′, rubber sheets 14, 14′, flat metal plates 15, 15′, and heated platens 16, 16′ of a platen press (not shown). FIG. 2 is a schematic representation of a continuous process in which calendering equipment fitted with temperature, pressure and speed controls (not shown) is employed for embossing sheet in accordance with the present invention. Sheet 21 comprising thermoplastic polymer is forwarded from feed roll 22, under idler roll 23, through a nip formed by back-up roll 24 and embossing roll 25 to windup roll 26. A film stamper of the invention is attached to embosser roll 25 (as illustrated hereinafter in Example 6). In another embodiment of a continuous process of the invention, an embosser film is passed through the nip while in surface-to-surface contact with sheet 21 and then separated therefrom downstream of the nip (as illustrated hereinafter in Example 7). Conventional means for heating sheet 21, prior to or during passage through the nip are not shown.

Further details and descriptions of the equipment depicted in FIGS. 1 and 2 are given in U.S. Pat. No. 6,120,719, the entire disclosure of which has been incorporated herein by reference.

### DETAILED DESCRIPTION OF PREFERRED EMBODIMENTS

The meanings of various terms used herein are as follows:

“fibrous sheet” includes within its meaning knit, woven, nonwoven, spunbonded, spunlaced, stitch-bonded, felted fabric and the like;

“fibrous element” includes within its meaning fiber, filament, thread, yarn, microfiber, fibril and the like;

“fine grooves” means parallel grooves or segments of parallel grooves that are spaced apart uniformly by about 0.1 to 10 micrometers (microns) and are at least 0.01 micron deep and typically are less than 0.5-micron deep;

“deep grooves”, also means parallel grooves or segments of parallel grooves that are spaced apart uniformly by about 0.1 to 10 micrometers (microns), but in contrast to fine grooves, are at least 1 micron deep;

“film” includes within its meaning fibrous sheets laminated or coated with a layer of film on at least one of its surfaces;

“metallized” refers to thin layer of a metal particles deposited (usually by metal-vapor vacuum-deposition) on the surface of a fibrous sheet or film; and

“film shim” refers to a flexible plastic film having patterns of grooves pre-embossed on its surface which when viewed at an angle to incident light produce rainbow or hologram images.

In accordance with the present invention, a shim of polymeric film is used in place of a conventional metal shim (as has been used heretofore), to emboss a groove pattern from the film shim to the surface of a sheet. The sheet that is to be embossed includes thermoplastic polymer in its surface. Suitable sheet for embossing by the process of the invention includes a permeable fibrous sheets that has thermoplastic fibrous elements on its surface, an impermeable thermoplastic film, a fibrous sheet that is coated or laminated with a layer of thermoplastic polymer, and the like.

Sheet embossed by the process of the invention is provided with groove patterns that produce rainbow and/or hologram images. The images are visible to the naked eye when the sheet surface is viewed at an angle to incident light, especially sunlight or incandescent light. The patterns of grooves or clusters of groove segments on individual fibrous elements of a breathable fibrous sheet are substantially aligned from fibrous element to fibrous element and continue to neighboring fibrous elements in phase, such that the distance between the last groove on one fibrous element and the first groove on the neighboring fibrous element is an integer multiple of the groove width. The patterns of grooves or clusters of groove segments on the surface of a continuous impermeable film surface are aligned along the film surface in the same manner as the grooves are aligned on the surface of the film shim. The grooves on the surface of the embossed sheet are spaced apart uniformly by about 0.1 to 10 microns and are at least 0.01-micron deep. Groups of straight, parallel fine grooves or deep grooves, produce rainbow colors, referred to herein as “rainbow images”. Groups of parallel fine or deep groove segments having straight, curved or wavy configurations produce hologram images.

In accordance with the improvement of the present invention, the embossing shim is made of a flexible polymeric film, such as polyester film. The shim is pre-embossed with rainbow or hologram patterns. When such a film embosser shim is employed in place of a conventional metal shim in a platen press operating under the same conditions of temperature and pressure as are used with a metal shim, the film shim produces hologram images of high quality on films and on fabrics made with fibers of thermoplastic polymers, even when the thermoplastic fiber of the sheet to be embossed is of the same polymer as the film shim. Shim film of polyester polymer is preferred. The embossing film shim has good dimensional stability and durability under the embossing conditions and can be used repeatedly to form many high quality rainbow and/or hologram images on films and fabrics.

The process of the present invention can be performed either batch-wise or continuously under conditions of temperature and pressure that are substantially the same as those illustrated in the examples of U.S. Pat. No. 6,120,710. To produce satisfactory hologram and/or rainbow images with the process of the present invention, the embossing temperature typically is maintained above the softening temperature of the thermoplastic polymer in the sheet being embossed, The softening temperature is determined at the pressure of the embossing. The pressure of embossing is sufficiently high to produce bright hologram images without causing fusion or melting of the polymer of the sheet being embossed. To produce hologram and/or rainbow images of high intensity colors, the film embosser shim has deep grooves that are at least 1-micron deep. Generally, the grooves are in the range of 1.5 to 7 microns deep. Deeper grooves provide brighter images. Grooves of at least 2 microns in depth are preferred.

In accordance with the process of the present invention hologram and/or rainbow images can be embossed on sheet materials, in a continuous, low-cost process that employs conventional fabric-calendering machines. For example, a roll of flexible plastic film shim having a deep groove pattern can be fed along with the sheet to be embossed into the nip of calender rolls to emboss the hologram pattern onto the surface of the sheet. Downstream of the nip, the embosser film shim can be separated from the sheet and rolled up on a core for subsequent re-use. Sheet or film that includes thermoplastic polymer in its structure or on its surface is suitable for use in the present process. Suitable thermoplastic polymers include polyester, nylon, polypropylene, polyethylene and the like and combinations or blends of such polymers with non-thermoplastic fibers or materials.

### EXAMPLES

The following examples illustrate preferred embodiments of the invention. Hologram and/or rainbow groove patterns are embossed on the surfaces of various fabrics, sheets and films. In each example, an embosser shim of polyester film is employed. Examples 1-5 illustrate the invention with batch processes that employ equipment of the type depicted in FIG. 1, in which the film shim corresponds to the part designated 12 and the material being embossed corresponds to the part designated 10. Examples 6 and 7 illustrate the invention with continuous processes of the kind depicted in FIG. 2.

### Example 1

A swatch of black colored polyester satin fabric (style no. 784750, manufactured by Milliken & Co. USA) having 16.5-by-20 ends/cm on the satin side and 24.5-by-27.5 ends on the back side and weighing 111 g/m², is embossed with a “Crystals” hologram pattern in a batch process using an 8.6-cmong, 7.6-cm-wide, 0.0076-cm. (0.003-inch) thick, transparent, polyester film shim. The shim was cut from a 157-cm wide roll of polyester film with a pattern designated as “Crystals-deep Grooves” manufactured by Spectratek Technologies, Inc., USA. The film shim has a “crystals” hologram pattern provided by groups of 2-micron deep grooves embossed on one surface of the shim. The film shim with its grooved surface is placed in direct contact with the satin side of the fabric and an assembly of the type shown in FIG. 1 is formed. The assembly is placed between the platens of a press that is preheated to 185° C. A pressure of 20,684 KiloPascals (3,000 psi), a pressure calculated on the basis of the film shim area, is then applied for 5 minutes. The assembly is then removed from the press and the fabric is separated from the film shim. An excellent embossed hologram image of the “crystals” pattern appeared with bright rainbow colors on the fabric surface when viewed under sunlight or incandescent light. The flexibility and breathability of the fabric is substantially unaffected by the embossing..

To determine the stability and durability of the embosser film shim (i.e. stamper) over multiple cycles of use, the procedure of the preceding paragraph is repeated numerous times with the same polyester film shim to emboss different swatches of the same black polyester satin fabric. Twenty embossing uses produce no perceptible differences in color brightness between the hologram on the first fabric embossed and the hologram on the twentieth fabric embossed. Color brightness diminishes only slightly after about thirty embossing uses. The film shim retains its dimensional stability and flexibility but under the embossing conditions of this example, the film shim acquires a tint of gray color caused by the transfer of dye from the black fabric.

To compare the effects of the groove depth of the embosser film shim on the quality of the hologram images produced, the procedure of the first paragraph of example I is repeated with a metallized polyester film shim having a “Spectratek Hearts” hologram pattern. The shim measures 9.65-cm long, 7.6-cm wide and 0.005-cm (0.002-inch) thick and has embossing-pattern grooves or less than 1-micron depth. A pressure of 18,140 kiloPascals and a temperature of 185° C. are maintained for four minutes. Although the hearts hologram pattern is faithfully reproduced on the fabric surface, the color of the resultant hologram is significantly less intense than that of the hologram images produced with the deep groove film shim of the preceding paragraphs.

### Example 2

A swatch of white polyester satin fabric (manufactured by Milliken & Co. USA) having 15-by-29 ends/cm on the satin front side and 21.5-by-24 ends on the back side and weighing 101 g/m² is embossed in the same manner as in Example 1, except that the embossing temperature is 190° C. and the pressing time is 4 minutes. The thusly-embossed fabric has good hologram images, but with relatively faint colors as compared to the hologram images of the embossed fabric of Example 1. A good hologram image with similarly faint colors is also obtained when a thinner film embosser shim having the same deep groove pattern is used in the same procedure (i.e., with a film embosser shim of 0.005-cm thickness in place of the 0.0076-cm thick film embosser shim). However, when the embossed surface of the fabric swatches are metallized by vapor-depositing a continuous layer of aluminum particles on the embossed surface, the color brightness of the hologram images are greatly enhanced.

### Example 3

A 14cm by 14-cm. swatch of a gray colored polyester knit fabric (style no. 692386, manufactured by Milliken & Co. USA) having 17-by-18.5 ends/cm and weighing 149 g/m² is embossed by the procedure of Example 1, except that the embossing pressure is 4557 KPa and the embossing time is 3 minutes. Hologram images of good color intensity are produced..

### Example 4

The procedure of Example 1 is repeated, but with a black-colored knit nylon/LYCRA spandex® blend foundation fabric, having 25 wales/cm-by-30 courses/cm and weighing 173 g/m², and with an embossing temperature of 175° C., an embossing pressure of 13789 KPa and an embossing time of one minute. Holograms of good color intensity are produced on fabric surface.

### Example 5

The procedure of Example 1 is repeated, but with a sheet of 0.0025-(0.001inch) thick metallized polyester film and an embossing time in the press of 4 minutes. Hologram images of outstanding color intensity are produced on the metallized surface of the sheet. The procedure is repeated again with sheet turned upside down so that the non-metallized side directly contacts the grooves of the embossing film shim. Again good hologram images are produced on the film surface, but the colors are of lesser intensity than those produced on the metallized surface.

### Example 6

In this example, equipment that is conventionally used for embossing fabric labels for garments is employed substantially as depicted in FIG. 2 to form hologram images on the surface of a fabric in a continuous process. The equipment, which is typical of that conventionally used for embossing fabric labels for garments, is similar to that illustrated in FIG. 2. A 2.54-cm by 2.54-cm swatch of the polyester film shim used in Example 1 is bonded to the surface of embossing roll 25. A 15.25-cm wide roll 22 of the black polyester satin fabric described in example 1 is fed into the nip between embossing roll 25 and backup roll 24 and is collected on windup roll 26. Embossing roll 25 is 23-cm (9-in) wide. Backup roll 24 has a Durometer hardness of about 100. The embossing roll is preheated to 182° C. The satin polyester fabric is forwarded through the nip at 60 cm/min. Squares of “Crystals” hologram images of good quality are produced along the centerline of the black polyester satin fabric that passes through the nip. The fiftieth embossed image is as bright as the first. Successive embossing repetitions, after the fiftieth embossed image, result in a gradual decrease in the color intensity of the hologram images formed on the fabric. .

### Example 7

In this example, a fabric-calendering machine similar to that depicted in FIG. 2 is employed. However, embossing roll 25 is a smooth roll having no embossing shim attached to its surface. Instead, a second feed roll supplies a polyester film shim of the type used in Example 1. The deep-groove film shim is fed into the nip between back-up roll 24 and embossing roll 25 along with sheet (or film) 21 which is to be embossed. Downstream of the nip, the film shim is separated from the embossed sheet and is wound on a windup roll separate from the windup roll 26. With the embossing roll is heated to a temperature of about 190° C. and with a load in the nip of about 7 kilograms per cm of roll width, hologram images of good color intensity are produced on 150-cm wide fabric and film..

Many different embodiments of the invention may be made without departing from the spirit and scope of the invention. The scope of the invention is not intended to be limited, except as set forth in the appended claims.

I claim

1. An improved process for forming rainbow and/or hologram images on the surface of a sheet or film, wherein a sheet or film having surface elements of thermoplastic polymer is softened and subjected to sufficient heat and pressure while in contact with an embossing shim having a groove pattern on its surface to emboss the groove pattern upon the surface of the sheet or film, the improvement comprising
the embossing shim being a polymeric film of at least 0.0025-cm thickness and having deep grooves of at least 1-micron depth.

2. A process according to claim 1 wherein the groove depth is in the range of 1.5 to 7 microns.

3. A process according to claim 1 wherein the polymeric film of the embossing shim is of polyester film.

4. A process according to claim 1 wherein the polymeric film embosser shim is attached to the surface of one of a pair of rolls which form a nip through which the sheet or film to be embossed is passed in a continuous process.

5. A process according to claim 1 wherein a long strip of the polymeric film embosser shim is passed in a continuous process in face to face contact with the sheet to be embossed through a nip formed by a pair or rolls.
